(19) United States
(12) Patent Application Publication
(10) Pub. No.: US 2020/0369197 A1
(43) Pub. Date: Nov. 26, 2020

(54) Clamping Device for Trailer Truck

(71) Applicant: Chao-Heng Lin, Taiyuan City (TW)

(72) Inventor: Chao-Heng Lin, Taiyuan City (TW)

(21) Appl. No.: 16/419,044

(22) Filed: May 22, 2019

(51) Int. Cl. B60P 7/08

(52) U.S. Cl. CPC B60P 7/0807; B60P 7/083

(57) ABSTRACT

A clamping device for a trailer truck includes a connecting member, a positioning member mounted on the connecting member, a driving member pivotally connected with the connecting member, and a clamping member pivotally connected with the driving member. The connecting member is provided with a threaded rod. The positioning member is screwed onto the threaded rod. The clamping device is mounted on a crossbar of a trailer truck. The crossbar of the trailer truck is clamped between the connecting member and the clamping member by driving the driving member. When the crossbar of the trailer truck is unlocked from the clamping device, the clamping device is movable on the crossbar of the trailer truck.

### BACKGROUND OF THE INVENTION

### 1. Field of the Invention

The present invention relates to a trailer truck (or tow truck) and, more particularly, to a clamping device for a trailer truck.

### 2. Description of the Related Art

A conventional trailer truck 10 in accordance with the prior art shown in FIG. 1 comprises two bottom rails 103, two recessed holders (or stake pockets) 104 respectively mounted on the two bottom rails 103 by soldering, and two fixtures (or lashing winches) 101 respectively mounted on the two recessed holders 104 by insertion. Each of the two fixtures 101 includes a pressing member 1011. In practice, a cargo 102 is placed on the trailer truck 10 and is tied by a cable 105. The cable 105 has two ends attached to the two fixtures 101 respectively. Each of the two ends of the cable 105 is pressed and tightened by the pressing member 1011 of each of the two fixtures 101, such that the cargo 102 is positioned in place by the cable 105. However, the two recessed holders 104 are soldered on the two bottom rails 103, such that the position of each of the two fixtures 101 is fixed and cannot be adjusted according to the practical requirement (such as size or location) of the cargo 102, thereby causing inconvenience to the user in binding the cargo 102.

### BRIEF SUMMARY OF THE INVENTION

The primary objective of the present invention is to provide a clamping device whose location is changed according to the practical requirement.

In accordance with the present invention, there is provided a clamping device comprising a connecting member, a positioning member mounted on the connecting member, a driving member pivotally connected with the connecting member, and a clamping member pivotally connected with the driving member. The connecting member is provided with a threaded rod. The positioning member is screwed onto the threaded rod of the connecting member. The driving member is provided with a pull handle. The clamping member is provided with a positioning groove. A receiving space is defined between the connecting member and the clamping member. The clamping device is mounted on a crossbar of a trailer truck. The crossbar of the trailer truck is received in the receiving space and arranged between the connecting member and the clamping member. When the crossbar of the trailer truck is unlocked from the clamping device, the clamping device is movable on the crossbar of the trailer truck.

Preferably, the positioning member is swiveled relative to the connecting member through 360 degrees.

Preferably, the positioning member has a type that is changed such that the positioning member is available for trailer trucks of different types.

Preferably, the retaining member has a D-shaped configuration.

Preferably, the clamping member is connected with the driving member by a hinge.

Preferably, a retaining member is pivotally mounted on the positioning member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional trailer truck in accordance with the prior art.

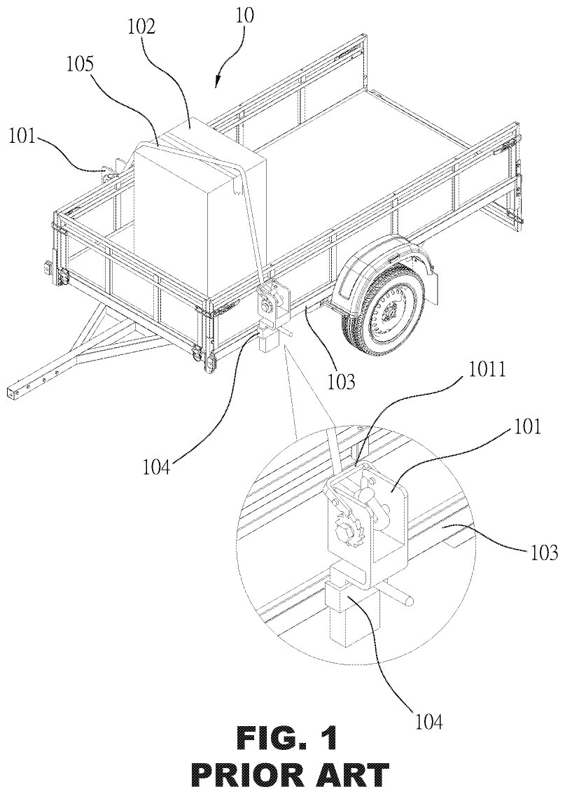

FIG. 2 is an exploded perspective view of a clamping device in accordance with the preferred embodiment of the present invention.

FIG. 3 is a perspective operational view of the clamping device in accordance with the preferred embodiment of the present invention.

FIG. 4 is a side operational view of the clamping device for a trailer truck in accordance with the preferred embodiment of the present invention.

FIG. 5 is a perspective view of the clamping device for a trailer truck in accordance with the preferred embodiment of the present invention.

FIG. 6 is a side view of the clamping device for a trailer truck in accordance with the preferred embodiment of the present invention.

FIG. 7 is a side operational view of a clamping device for a trailer truck in accordance with another preferred embodiment of the present invention.

FIG. 8 is a perspective operational view of the clamping device for a trailer truck in accordance with the preferred embodiment of the present invention.

FIG. 9 is a perspective operational view of a clamping device in accordance with another preferred embodiment of the present invention.

FIG. 10 is a perspective view of the clamping device for a trailer truck in accordance with another preferred embodiment of the present invention.

### DETAILED DESCRIPTION OF THE INVENTION

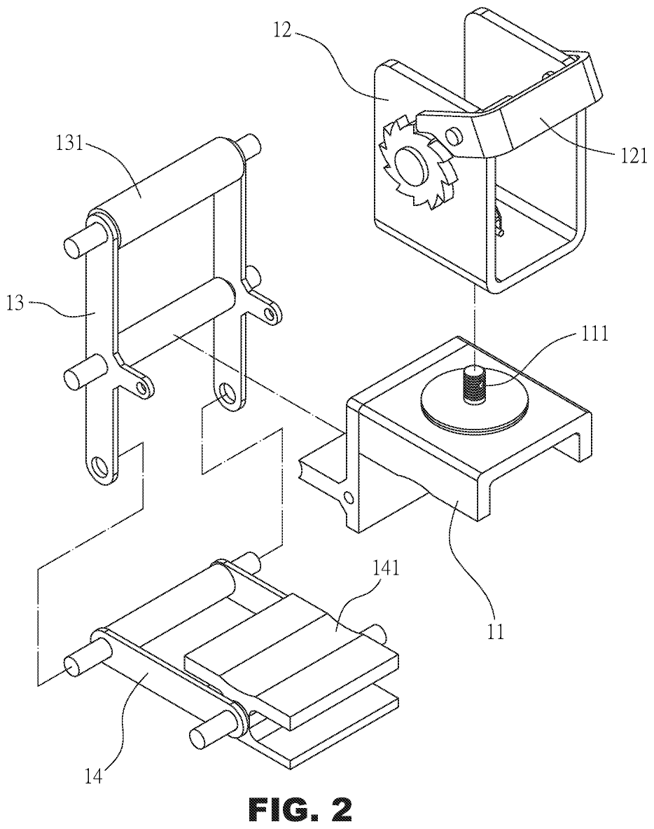

Referring to the drawings and initially to FIGS. 2-6, a clamping device 1 in accordance with the preferred embodiment of the present invention comprises a connecting member (or bracket or piece or block) 11, a positioning member (or bracket or piece or block or lashing winch) 12 mounted on the connecting member 11 by screwing, a driving member 13 pivotally connected with the connecting member 11, and a clamping member (or board or plank or plate) 14 pivotally connected with the driving member 13.

The connecting member 11 is provided with a threaded rod 111. The positioning member 12 is screwed onto the threaded rod 111 of the connecting member 11. Preferably, the positioning member 12 is provided with a threaded portion screwed onto the threaded post 111 of the connecting member 11. A retaining member (or pressing member or snap ring) 121 is pivotally mounted on the positioning member 12. The driving member 13 is provided with a pull handle 131. The clamping member 14 is provided with a positioning groove 141. A receiving space is defined between the connecting member 11 and the clamping member 14.

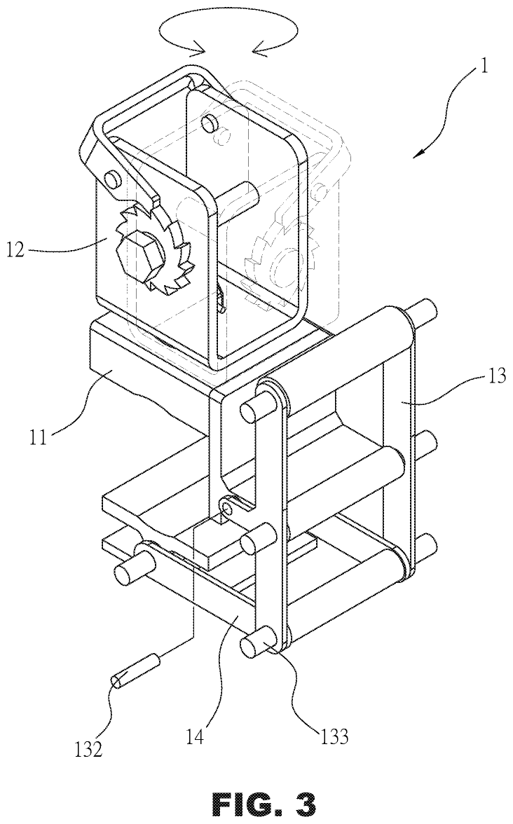

In assembly, the positioning member 12 is screwed onto the threaded rod 111 of the connecting member 11. Then, the driving member 13 is pivotally connected with the connecting member 11 by pins 132. Then, the clamping member 14 is connected or linked with the driving member 13 by a hinge (or pivot) 133, such that the clamping member 14 is moved upward or downward in concert with the driving member 13 by the hinge 133. Thus, the connecting member 11, the positioning member 12, the driving member 13, and the clamping member 14 are assembled to construct the clamping device 1. At this time, the positioning member 12 is swiveled relative to the connecting member 11 through three hundred and sixty degrees (360°), to adjust the angle of the positioning member 12 as shown in FIG. 3. When the driving member 13 is driven, the clamping member 14 is driven by and moved with the driving member 13 upward or downward, to adjust the distance between the clamping member 14 and the connecting member 11.

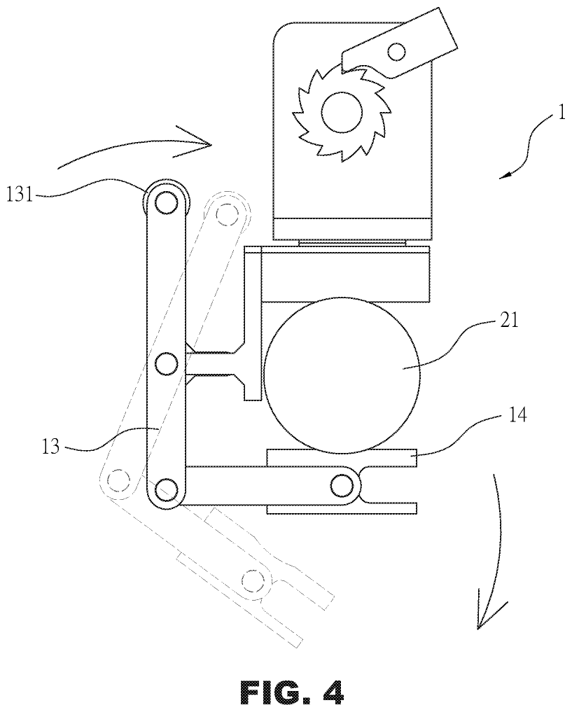

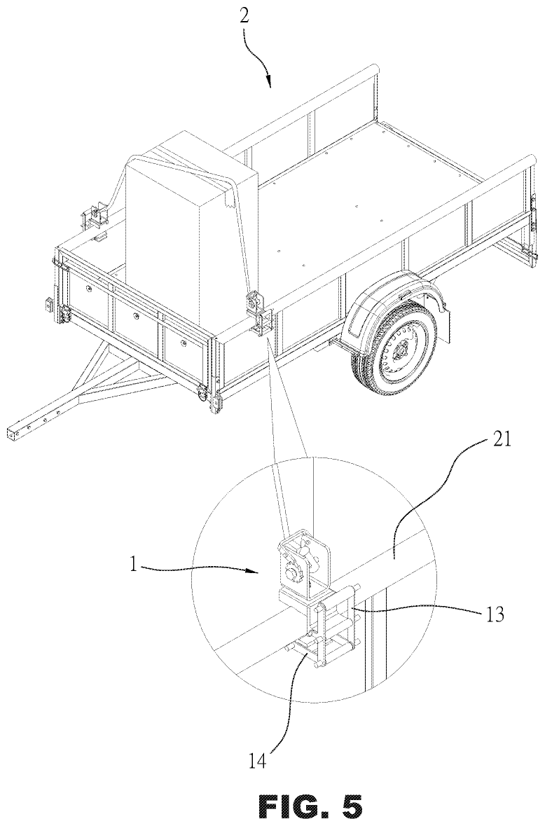

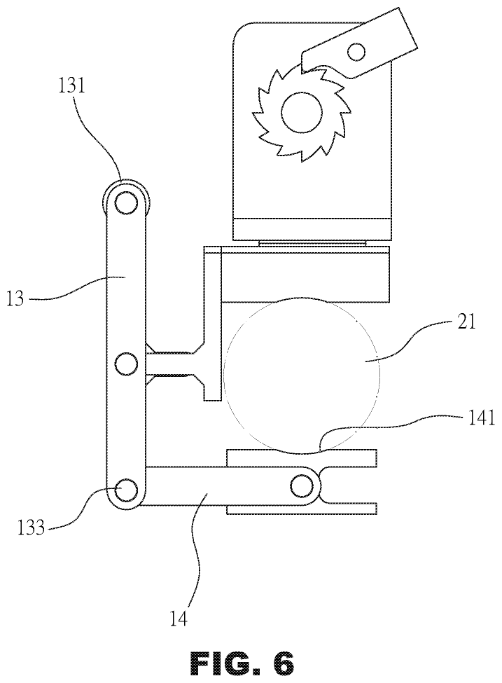

In operation, referring to FIGS. 4-6 with reference to FIGS. 2 and 3, when the clamping device 1 is mounted on a crossbar (or transverse rod or rail) 21 of a trailer truck 2, the crossbar 21 of the trailer truck 2 is received in the receiving space and arranged between the connecting member 11 and the clamping member 14. When the pull handle 131 of the driving member 13 is pushed forward, the clamping member 14 is moved downward, to unlock and release the crossbar 21 of the trailer truck 2. When the pull handle 131 of the driving member 13 is pulled backward, the clamping member 14 is moved upward, to clamp and lock and release the crossbar 21 of the trailer truck 2, such that the crossbar 21 of the trailer truck 2 is clamped between the connecting member 11 and the clamping member 14. At this time, the crossbar 21 of the trailer truck 2 is positioned in the positioning groove 141 of the clamping member 14 as shown in FIG. 6. Thus, the clamping device 1 is locked onto the crossbar 21 of the trailer truck 2 as shown in FIG. 5. In addition, when the crossbar 21 of the trailer truck 2 is unlocked from the clamping device 1, the clamping device 1 is movable on the crossbar 21 of the trailer truck 2. As shown in FIG. 4, the crossbar 21 of the trailer truck 2 has a circular shape.

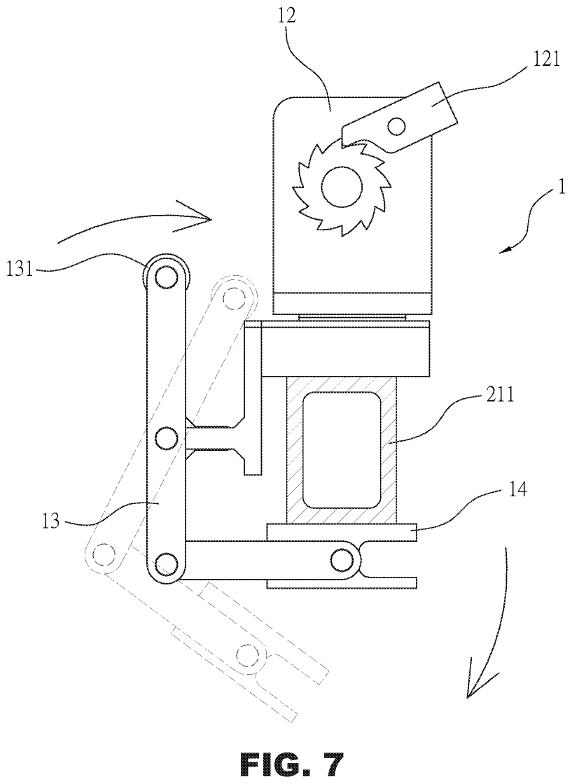

As shown in FIG. 7, the crossbar 211 of the trailer truck 2 has a flat shape or rectangular cross-sectional shape. Thus, the clamping device 1 is available for trailer trucks of different types.

Accordingly, the clamping device 1 is locked or unlocked by operating the driving member 13, such that the clamping device 1 is locked onto or unlocked from the crossbar 21 of the trailer truck 2 easily and conveniently, thereby facilitating the user operating the clamping device 1. In addition, when the clamping device 1 is unlocked, the clamping device 1 is moved on the crossbar 21 of the trailer truck 2 to change the location of the clamping device 1. Further, the positioning member 12 is swiveled relative to the connecting member 11 through 360 degrees, such that the positioning member 12 of the clamping device 1 is angle adjusted.

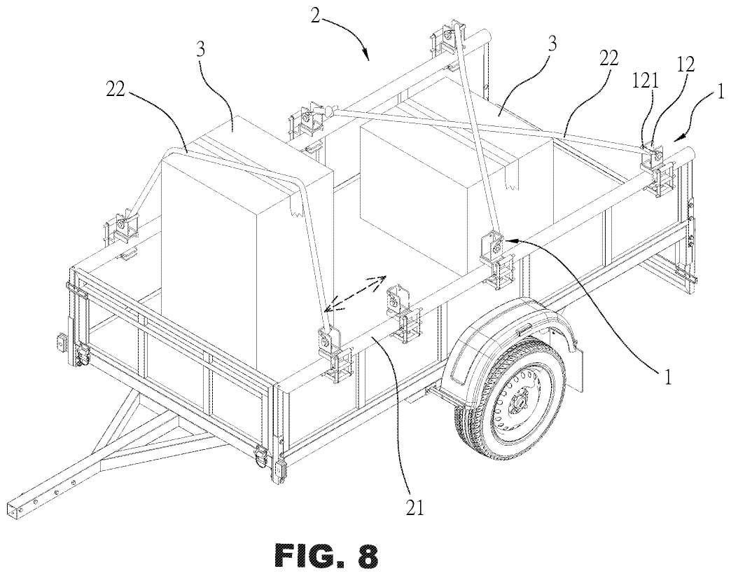

Referring to FIG. 8 with reference to FIGS. 2-6, cargos 3 are placed on the trailer truck 2 and bound (or tied) by multiple ropes 22 which are fastened by multiple clamping devices 1. The retaining member 121 of the positioning member 12 of each of the clamping devices 1 presses each of the ropes 22, such that the ropes 22 are tightened by the clamping devices 1. In such a manner, the positioning member 12 is swiveled relative to the connecting member 11 through 360 degrees, such that the positioning member 12 of each of the clamping devices 1 is angle adjusted to fit the orientation of each of the ropes 22. Thus, the cargos 3 are bound by the ropes 22 tightly and closely. In addition, when each of the clamping devices 1 is unlocked, each of the clamping devices 1 is moved on the crossbar 21 of the trailer truck 2, to change the location of each of the clamping devices 1, thereby facilitating the user locating and binding the cargos 3. Thus, the location of each of the clamping devices 1 is adjusted according to the size of each of the cargos 3.

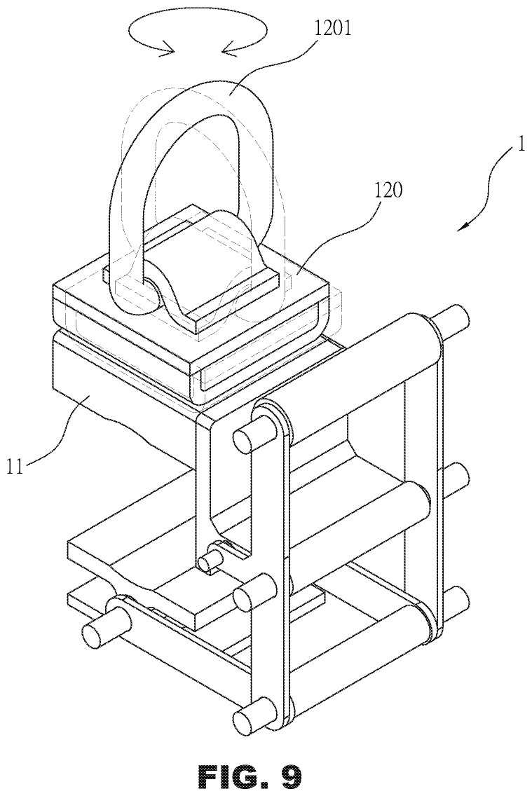

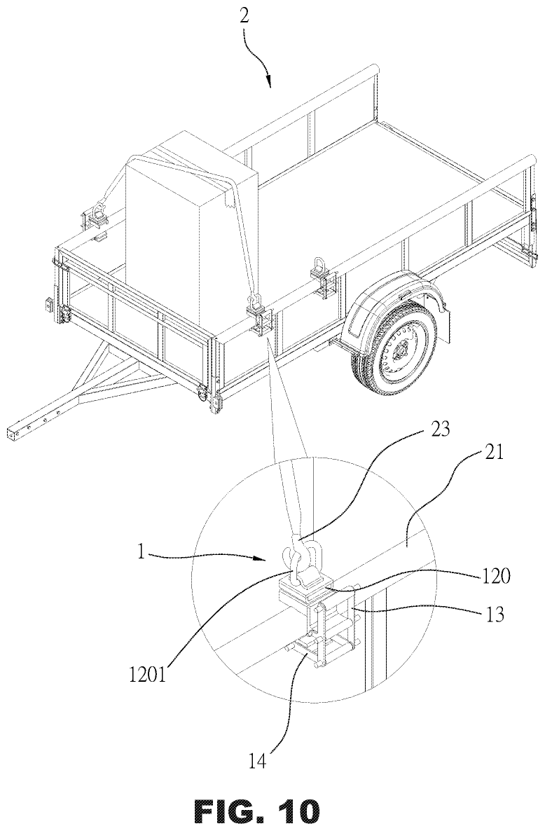

Referring to FIGS. 9 and 10, a movable D-shaped retaining member (or snap ring) 1201 is pivotally mounted on the positioning member 120. In practice, a hook 23 of the trailer truck 2 is hooked onto the D-shaped retaining member 1201 of the clamping device 1. Thus, the type of the positioning member is changed such that the positioning member is available for trailer trucks of different types.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A clamping device comprising:
a connecting member;
a positioning member mounted on the connecting member;
a driving member pivotally connected with the connecting member; and
a clamping member pivotally connected with the driving member;
wherein:
the connecting member is provided with a threaded rod;
the positioning member is screwed onto the threaded rod of the connecting member;
the driving member is provided with a pull handle;
the clamping member is provided with a positioning groove;
a receiving space is defined between the connecting member and the clamping member;
the clamping device is mounted on a crossbar of a trailer truck;
the crossbar of the trailer truck is received in the receiving space and arranged between the connecting member and the clamping member; and
when the crossbar of the trailer truck is unlocked from the clamping device, the clamping device is movable on the crossbar of the trailer truck.

2. The clamping device of claim 1, wherein the positioning member is swiveled relative to the connecting member through 360 degrees.

3. The clamping device of claim 1, wherein the positioning member has a type that is changed such that the positioning member is available for trailer trucks of different types.

4. The clamping device of claim 1, wherein the retaining member has a D-shaped configuration.

5. The clamping device of claim 1, wherein the clamping member is connected with the driving member by a hinge.

6. The clamping device of claim 1, wherein a retaining member is pivotally mounted on the positioning member.
